(19) United States
(12) Patent Application Publication
(10) Pub. No.: US 2011/0302016 A1
(43) Pub. Date: Dec. 8, 2011

(54) AUTOMATED MEMBERSHIP SYSTEM

(75) Inventor: Aneace Hadi Haddad, Singapore (SG)

(73) Assignee: TAGGO PTE LTD., Singapore (SG)

(21) Appl. No.: 13/201,814

(22) PCT Filed: Jan. 28, 2010
(86) PCT No.: PCT/SG10/00025

§ 371 Date: Aug. 16, 2011

(30) Foreign Application Priority Data
Feb. 17, 2009 (SG) 200901125-5

(51) Int. Cl. G06Q 30/00

(52) U.S. Cl. 705/14.25; 705/14.27

(57) ABSTRACT

An automated membership system including (i) an article containing readable data to identify a user and (ii) a server for (a) storing the profile data of the user, the profile data including data representing a first identifier; (b) receiving from the user a request message identifying a vendor; (c) providing the user's profile data to the vendor, so as to enable the vendor to carry out a transaction with the user based on a second identifier; (d) storing the second identifier in association with the user's profile data, wherein the vendor accesses the second identifier based on a query including the first identifier read from the article, so as to enable the vendor to carry out a transaction with the user based on the second identifier.

### FIELD

The invention applies to the field of processing loyalty card membership enrolment applications as well as transactions performed after enrolment is completed. In particular, present invention described in this specification relates to, but is not limited to a solution to automate the membership application process by allowing customers to use their existing mobile phones to enrol in many existing loyalty programmes simply by sending a short message with a keyword each time the customer wants to join a retailer's programme, with no need to fill out and submit application forms to each retailer. Instantly, upon approval of an enrolment application, the user's mobile phone, or other portable object, is made capable of being used at the retailer's checkout counter through a “tap and go” feature. The representative embodiments described herein can work with any mobile phone, with no need for built-in contactless chip technology, no need to load applications or data to phones when customers join new programmes, and no need for retailers to engage in complicated and costly modification or replacement of their existing loyalty systems.

### BACKGROUND

Faced with the growing proliferation of loyalty cards offering points accumulation, cash back and discount schemes, retailers are finding it more and more difficult to convince customers to apply for their card and join the retailer's loyalty programme. Many customers already have too many cards in their wallets and prefer not to enrol in new programmes. Customers that are already enrolled often leave many of their cards home, causing them to miss out on discounts.

A recent survey by Aneace Haddad shows that 40% of customers in Singapore own five or more loyalty or discount cards yet typically carry less than three in their wallets at any one time. Almost nine out of ten members of this group are women. Another 30% of respondents own less than three loyalty cards and don't like to be bothered with the enrolment process involved in applying for cards. Almost eight out of ten of this group are men. The results of the study did not show that men are not interested in discounts and loyalty rewards. Instead, the study showed that because men don't generally carry large wallets or purses, they are therefore constrained in the number of cards that they can carry and programmes that they can join.

The current method of enrolling customers consists of requiring them to fill out a loyalty card application form, sometimes accompanied by an initial payment or processing fee. The application form can be dropped off at one of the retailer's stores, the application is processed and the card is sent to the customer by mail. Alternatively, the form can sometimes be filled out at a dedicated service counter in the store and the application processed immediately, allowing the card to be delivered to the customer on the spot so it can be used immediately. Drawbacks with the current methods include the hassle of filling out forms for each loyalty programme, waiting to receive cards in the mail, waiting for the card to be prepared at a service counter, as well as carrying additional cards in one's wallet.

The most common existing solution for customers to enrol easily in many different retailer loyalty programmes is for retailers to group together as a coalition, in which customers can use a single card for benefits at all participating retailers. Customers have only to enrol once, and can carry a single card in their wallets. However, coalition programmes almost always include a single retailer in each category, such as one petrol retailer, one supermarket chain, one department store chain, etc., which limits the number of retailers that can accept the card. Another drawback is that each retailer has no direct relationship with customers, as customers only enrol in the coalition programme itself, not in each retailer's individual programme. This limits the ability for retailers to communicate directly with customers. In effect, the retailer no longer has a loyalty programme but is part of a larger programme. Most retailers prefer to run their own programmes and offer the benefits and rewards they want without having to submit to rules and agreements governing each participant in a coalition.

Many companies are developing ways to use mobile phones to replace all the cards in one's wallet. An obvious solution is for retailers to re-design their loyalty programmes to use the customer's mobile number as the loyalty card number. A typical example is a solution provided by Smart Transaction Systems (www.smarttransactions.com) in which customers enter their mobile numbers on a key pad each time they shop, and receive SMS text message updates for points balances and promotional offers. An obvious drawback with these solutions is that customers must enter their mobile numbers each time, but that can be remedied through contactless NFC technology that will be discussed below. A more difficult problem to solve is that customers that already have the retailer's existing loyalty card need to somehow transfer their benefits balance to their new mobile phone number ID, and, worse, retailers are required to modify their loyalty card numbering schemes to recognize mobile phone number IDs, something which is often difficult for retailers toy do if their loyalty system has been in use for some time. A more elegant solution would be to allow customers to use their existing loyalty card numbers, with no change to the retailer's numbering scheme, simplifying the process for both customers and retailers. In addition, and more to the point of the present invention, these solutions still require customers to fill out forms and register for each retailer's programme individually, so there is no improvement on current enrolment practices.

Mobile phones equipped with contactless “tap and go” technology offer another partial solution. Referred to as NFC (Near Field Communications) this technology promises to convert mobile phones into payment devices that can replace all the cards in one's wallet. There are currently two ways of implementing tap and go functionality on mobile phones. One way is to provide small stickers embedded with an NFC chip, that can be attached to mobile phones, while another way is to include the NFC chip as a built-in feature provided with the phone, much like Bluetooth and Wi-Fi capabilities. Both solutions offer some promise, yet both currently fall short of solving the problems addressed by the present invention.

First Data Corporation offers a product called GO-Tag, a typical example of contactless “tap and go” technology built into new form factors such as stickers that can be attached to mobile phones and other portable devices such as key rings. A product brochure describes the solution:
“GO-Tag form factors work like a premium gift card—they are alternative form factors like fobs, stickers, or wristbands, that have a prepaid amount loaded on them and are able to make contactless prepaid payments. The GO-Tag fob card is a smaller version of a standard gift card that can be attached to a key chain or other ring attachment. The GO-Tag sticker can be adhered to a customer's personal item—cell phone, employee badge or MP3 player. A customer will buy the GO-Tag form factor in a store that sells prepaid cards. Then when the customer pays for their purchase they simply wave or tap the GO-Tag form factor in front of a contactless reader at the point-of-sale (POS). Beyond the terminal, the transaction uses the existing gift card transaction-processing infrastructure. Though the end result is the same as if a cashier had swiped a card, this technology makes the purchasing experience more rewarding for the consumer.”

NFC stickers always broadcast the same unique ID, which is essentially the same ID that retailers would normally include on their existing cards. NFC stickers provide a similar solution to that provided by barcodes on loyalty cards and key fobs, as the NFC sticker broadcasts a unique ID similar to a barcode account number. NFC stickers are sometimes even referred to as “NFC barcodes”, even though there is no actual barcode on the stickers.

Current NFC sticker solutions (and even barcode solutions) do not simplify and streamline enrolment, as customers must still go through the normal membership application process consisting of filling out and submitting separate form for each retailer and waiting to receive each retailer's sticker, fob, wristband, etc., and even attaching multiple stickers to a mobile phone. These solutions are simply a different form factor for existing plastic card based programmes.

In summary, the practical utility of NFC stickers is currently limited:
Cards, stickers, tags, key fobs, etc., one for each retailer's programme, need to be physically created and delivered to customers.
Multiple stickers need to be attached to the mobile phone, one for each programme.
It is impossible to add new programmes to a phone without adding new stickers.
The enrolment process remains the same, since customers must enrol in each retailer's programme.

Another partial solution consists of NFC chips built into phones and linked to “mobile wallet” applications that customers download into their phones for payment cards, loyalty cards, coupons and other information. The NFC chip inside the phone is more flexible than NFC stickers, for two reasons: a) the NFC chip inside the phone communicates with the mobile wallet application loaded in the phone's memory, and b) the NFC chip can be caused to broadcast a different ID, depending on the virtual card that is being presented to a retailer's point of sale reader.

A typical example is NTT's Key-Shuttle mobile wallet and Gyazapo platform. An NTT press release describes the solution:
“Users can easily register, access or overwrite membership and loyalty data just by waving their mobile phone, equipped with a contactless IC chip, over a terminal in a retail shop. The system, named Gyazapo, frees users from carrying and searching through multiple rewards cards while shopping. By simply waving their phone over the terminal, they can enjoy the convenience and benefits of shopping with membership services, including customer rewards and discounts. Once a dedicated application is downloaded into the phone, Key-Shuttle enables loyalty points, ID photos and other membership information of multiple retailers to be registered under a single platform. The system includes features for security and privacy, such as unauthorized access detection and user-required permission before a retailer can share membership information with other retailers. Reward cards registered in Gyazapo are more difficult to duplicate or falsify than traditional plastic cards, making this a more secure system for loyalty programs.”

Another example is a mobile wallet offered by VIVOtech (www.vivotech.com), called the VIVOwallet. This solution allows customers to download programme details over the air, rather than waving the phone next to a registration device in the store. The VIVOtech website provides a description of another limitation of mobile wallet solutions, the need for users to pre-select the requested card within the wallet before the phone is waved at the cash register:
“Customers simply wave their mobile phone at a cash register enabled with the ViVOpay reader and the pre-selected card is transferred via NFC or other contactless technology to the merchant for a contactless payment transaction.”

Personalizing phones over the air with new applications has proven to be quite difficult. Many customers do not have Internet access built into their phones, and most of those that do have never actually learned to load applications over the air. One solution has been to pre-load applications when the phone is delivered, but then only new customers can benefit.

Mobile wallets require NFC contactless chip capabilities to be built into phones and cannot function with NFC stickers, so they are limited to the few phone models with NFC built in. This is because the mobile wallet application communicates with the retailer's point of sale system through the integrated NFC chip, broadcasting the customer's card number for that retailer, rather than the single unique ID that is broadcast by NFC stickers described previously. Since virtually no phones on the market currently have NFC capabilities built-in, the market for mobile wallets is negligible. And since NFC sticker products are unable to communicate with applications within the phone, there is no possibility to make a mobile wallet function with an add-on NFC sticker. Some combined products are beginning to appear, in which a much larger NFC sticker-type solution also includes Bluetooth connectivity to communicate with applications inside the phone, but these solutions are physically more cumbersome and more expensive than simple, thin NFC stickers.

The need to broadcast a different ID at each retailer creates other problems. The retailer's card ID needs to be injected into the mobile wallet, creating similar difficulties as with over the air downloading of applications. Furthermore, when paying at the cash register, the customer must first open the mobile wallet application on the phone and browse through the virtual cards stored on the phone to pre-select the applicable one, as described in the VIVOtech website quote provided above, so that the phone will broadcast the correct card ID. Instead of fumbling through one's traditional, physical wallet or purse, mobile wallet solutions now ask customers to fumble through their virtual wallets.

In summary, the practical utility of mobile wallets is limited:
Personalizing phones over the air with new applications or new programme data is very difficult.
There are still a very small number of phones with built-in NFC contactless chips.
Mobile wallets cannot function with low cost NFC stickers because there is no communications capability between the sticker on the phone and the mobile wallet application inside the phone.
Customers at the cash register need to open the mobile wallet application on their phones and pre-select the appropriate virtual card when they pay.

It is doubtful that mobile wallet systems could be easily modified to overcome these drawbacks. Using a mobile phone to replace all the cards in one's wallet has been something of a holy grail, and many people have been working on this, yet none of the current solutions avoid the problems described above. None of the existing mobile wallet solution providers even suggest the possibility of an extremely simple enrolment process, as all of these solutions require a physical connection with the phone for downloading new programme data. Likewise, none of the NFC sticker solution providers evoke the possibility of using a single sticker for many different independent programmes, despite the number of companies working in this area and the many people that must surely be aware of the drawbacks of requiring customers to attach multiple stickers to their phones.

A unique and innovative combination of some parts of each of these types of NFC technologies could be used to produce a simple and elegant solution when also combined with a smarter contactless reader configuration and another, unrelated technology: SMS text based ordering. Many advertisers invite customers to use SMS text messages to participate in promotions, enter sweepstakes, and request samples. Customers are asked to text their name, address and other details to a special number to participate. A solution called ShopText (www.shoptext.com) lets customers register their contact details once, including their payment details, so that in subsequent SMS text messages customers can simply include a keyword designating a promotion, service or product. Registered customers see an ad, order by text and confirm by pin via text to complete the order. This technique of ordering products and services through simple SMS text messaging does not in itself solve the problems addressed by the present invention, but it does provide an element of the solution when combined with some elements of both NFC stickers as well as NFC chips embedded within mobile phones, in addition to enhancements to current contactless reader configurations.

### SUMMARY

According to the present invention there is provided an automated membership system, including:

i) an article containing readable data representing a first identifier for uniquely identifying a user;
ii) a server configured for:
storing profile data for said user, the profile data including data representing said first identifier and other personal details of said user;
receiving, from said user, a request message identifying a vendor;
providing, in response to receiving said request message, said user's profile data to said vendor for creating a membership with said vendor, and receiving from said vendor, a second identifier uniquely identifying said user to said vendor; and
storing said second identifier in association with said profile data;
wherein, the vendor accesses said second identifier for said user based on a query including the first identifier read by the vendor from said article, so as to enable the vendor to carry out a transaction with said user based on the second identifier.

The present invention also provides a network-based membership enrolment method, including the steps of
adapting an article to contain readable data representing a first identifier for uniquely identifying a user;
storing profile data for said user on a server, the profile data including data representing said first identifier and other personal details of said user;
receiving, from said user, a request message identifying a vendor;
providing, in response to receiving said request message, said user's profile data to said vendor for creating a membership with said vendor, and receiving from said vendor, a second identifier uniquely identifying said user to said vendor;
storing said second identifier in association with said profile data; and
accessing said second identifier for said user based on a query from said vendor including the first identifier read by the vendor from said article, so as to enable the vendor to carry out a transaction with said user based on the second identifier.

### BRIEF DESCRIPTION OF THE DRAWINGS

Representative embodiments of the present invention are herein described, by way of example only, with reference to the accompanying drawings, wherein:

FIG. 1 is a diagram showing the components of the membership system;

FIG. 2 is a diagram showing the sequence of communications between a user device interacting with a server of the membership system;

FIG. 3 is a diagram showing one configuration of the membership system for use with a vendor's point of sales (POS) system;

FIG. 4 is a diagram showing another configuration of the membership system for use with a vendor's payment terminal;

FIG. 5 is a flow diagram of a first process performed under the control of the membership system; and

FIG. 6 is a flow diagram of a second process performed under the control of the membership system.

### DETAILED DESCRIPTION OF THE REPRESENTATIVE EMBODIMENTS

It would be beneficial to have a simple and elegant way for customers to easily enrol in many different retailer loyalty programmes without the traditional process of filling forms and waiting for cards to be produced when they join a new programme. It would be beneficial for such a solution to be available on all mobile phones on the market today, not just models with built-in NFC capabilities, and without requiring users to go through the hassle of loading special mobile wallet type applications on their phones. Clerks should not have to bother with the hassle of performing a special registration process to load programme data to phones before the phones can be used in a normal transaction. Customers at the cash register should not need to open special applications on their phones and fumble through their mobile wallets when they pay. It would be beneficial for the solution to allow retailers to each continue running their own distinct programmes with their own ID numbering schemes and not have to replace their loyalty systems or join coalition type programmes or adopt new ID schemes for participating customers. This also allows customers to retain their existing card numbers so that they don't need to use new account numbers and don't need to move rewards balances from their existing accounts to the new IDs. Furthermore, retailers should be able to continue running their traditional plastic card programmes at the same time as allowing some customers to use their mobile phones instead, with no distinction necessary between users.

The preferred embodiment of the present invention delivers all of these benefits by combining the following elements:
1. An SMS text message based enrolment system, with the specific feature of a single one-time registration process that eliminates the need for customers to re-enter their personal details each time they join a new programme, and that at the same time allows retailers to receive similar information to that provided by customers when they fill out forms.
2. Contactless NFC stickers that broadcast the customer's unique NFC ID, or mobile phones with built-in NFC chips configured to broadcast a single unique customer NFC ID, so there is no need to personalize phones when customers join a new programme, and no need for applications inside phones.
3. Smart contactless readers connected to a retailer's point of sale system, capable of consulting a central server and database to request conversion of the customer's unique NFC ID into the customer's corresponding ID for the retailer's loyalty programme, so retailers can continue using their current loyalty ID numbering schemes, and customers can retain their existing account numbers.

To begin, customers register once, either through a traditional PC or through their mobile phone equipped with a browser and mobile Internet access. Alternatively, registration could be accomplished through SMS text messages. The single registration process collects the customer's details, name, address, e-mail address, mobile phone number, etc. Customers are informed that this information will be automatically provided to retailers when they choose to enrol in those retailers' programmes. Billing information and payment details are also collected so that customers can be billed for any fees that retailers charge upon enrolment. Customers receive a small sticker that has an NFC chip embedded within it, and attach the sticker to their mobile phones or any other portable device. The sticker's unique ID is stored in the database with the rest of the customer's details. If a customer has a mobile phone that already provides tap and go capabilities, the phone's unique NFC ID is provided by the customer upon registration, and no sticker is required. In both cases, with NFC stickers and NFC chips embedded within the phones, the unique ID broadcast by the NFC sticker or chip never changes, so over the air updates are never required. Even when the customer enrols in new retail programmes, the NFC sticker or chip still broadcasts the same original unique ID.

When customers are shopping at participating retail outlets, they can instantly enrol in the retailer's loyalty programme by sending a simple SMS message to a special number. A central server receives this SMS and connects to the retailer's host to request a new loyalty ID for this customer, while at the same time providing the retailer's host with the customer's enrolment details. If any payment is required, the central server debits the customer's pre-provided account and provides the funds to the retailer. When the central server receives in response the retailer's corresponding loyalty ID created for this customer, the central server updates the customer's account details and adds the new loyalty ID to the customer's account. In this way, a link is created between the customer's unique mobile phone NFC ID and the customer's retailer specific loyalty ID. The customer's account can have many different retailer specific loyalty IDs linked to the customer's unique NFC contactless ID.

When a customer then proceeds to the checkout to pay, and the clerk asks if they have their loyalty card, the customer simply taps their phone on a dedicated NFC contactless card reader, instead of presenting their loyalty card. Unlike mobile wallet applications, there is no need to pre-select a virtual card before tapping the phone, and no need even to open the phone or switch it on. Tapping causes the reader to receive the NFC ID from the sticker fixed to the phone or built inside the mobile phone. The reader connects to the central server, submits the unique mobile phone NFC ID and requests the customer's corresponding loyalty ID for this retailer. When the customer's relevant loyalty ID is returned to the reader, it is submitted to the retailer's point of sale system just as if the retailer's own card had been swiped, so retailers can continue using their existing loyalty systems and existing ID numbering schemes.

A key benefit of the invention is that a customer waiting to pay at a retail counter can initiate the request to join the retailer's loyalty programme while in line, by simply sending an SMS message, and can then use the mobile phone immediately when it is his or her turn to pay, receiving the same benefits other customers get when they present their plastic loyalty cards. The present invention provides these benefits while at the same time avoiding the structural drawbacks of mobile wallets shown in Table 1 below.

TABLE 1

| Mobile Wallet Structural Drawbacks | Solved by Present Invention |
|---|---|
| Personalizing phones over the air | The present invention does not |
| with new applications or data is | require an application inside the |
| very difficult. | phone, and does not require new |
| | data sent to the phone when joining |
| | a new programme. |
| There are very few phone models | The present invention does not |
| available with built-in NFC | require an NFC chip built into the |
| contactless chips. | phone. |
| Mobile wallets cannot function | The present invention functions |
| with NFC stickers, as there is no | very well with a simple low cost |
| connection possible between the | NFC sticker attached to the phone. |
| sticker and the application | |
| inside the phone. | |
| Customers at the cash register | There is no need to pre-select a |
| need to open the mobile wallet | virtual card, and no need even to |
| application on their phones and | open the phone or select a special |
| pre-select the appropriate | application. |
| virtual card when they pay. | |

In the preferred embodiment, the invention includes the following elements:
A Registration Website, providing users the ability to register for the mobile loyalty wallet service.
A Central Server connected to a Database of Registered Users that receives enrolment requests from users and transmits the requests to retailer systems for approval.
A Mobile Phone Interface, providing users the ability to enrol in new programmes while shopping.
A Contactless Device, providing tap and go functionality, usually embedded within the phone or attached to the phone in the form of a sticker embedded with an NFC chip.
A Contactless Reader electronically connected to a retailer's point of sale system.

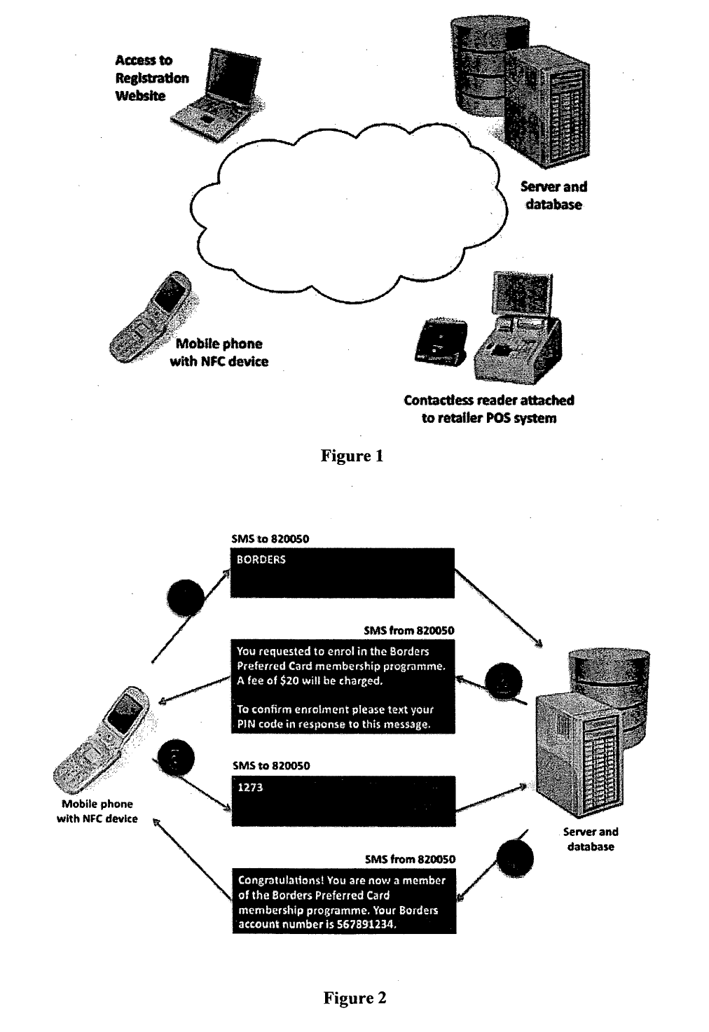

FIG. 1 shows all of the elements described above.

### Registration Website

Customers register once on this website, either through a PC or through their mobile phone equipped with a browser and mobile Internet access. The single registration process collects the customer's details, name, address, e-mail address, mobile phone number, etc. The customer is informed that this information will be automatically provided to retailers when the customer chooses to enrol in those retailers' programmes.

The customer is also requested to provide billing information and payment details so that they can be billed for any fees that retailers charge upon enrolment.

The customer is asked to enter a unique ID linked to their mobile phone and which provides “tap and go” capability, typically an ID linked to the phone's NFC (Near-Field Communications) capability, which some phones now offer. When the phone does not have such a feature built-in, the customer can obtain a small sticker that has an NFC chip embedded within it, and attach the sticker to their mobile phone.

### Central Server and Database of Registered Users

The Database contains the details for each registered user, including information provided at registration by users themselves through the Registration Website, as well as the retailer specific loyalty ID for each programme that a user has joined.

The Database may include the customer's payment details so that billing can happen automatically whenever the customer enrols in a programme that requires a fee.

The Database also includes a history of the customer's activity, including details on each programme that the customer has joined, as well as details of times and places where the customer's mobile phone was tapped, information that is available due to the server's lookup processing service described in paragraph c) below.

The Central Server provides the following services:
a) Receive mobile phone initiated, electronically generated requests from users wishing to enrol in a retailer's loyalty programme. Typically, the request will arrive in the form of an SMS message containing a key word such as ENROL followed by the retailer's unique ID, typically a 4 to 6 character code or number. The Central Server recognizes the user through the mobile phone number that sent the SMS request.
b) Send and receive data to the retailer's system to process the enrolment request instantly. The Central Server sends the request received above to the retailer's system, accompanied now with the customer's pre-provided enrolment details, including name, address, e-mail address, etc. If any payment is required, the central server debits the customer's pre-provided account and provides the funds to the retailer. Alternatively, the customer can pay later when billed for all the programmes that the customer has recently joined. The central server receives in response the retailer's corresponding loyalty ID created for this customer, updates the customer's account details and adds the new loyalty ID to the customer's account. In this way, a link is created between the customer's unique mobile phone NFC ID and the customer's retailer specific loyalty ID. The customer's account can have many different retailer loyalty IDs linked to the customer's unique NFC contactless ID.

As an alternative embodiment, the retailer may provide the Central Server with a list of pre-approved account numbers that the Central Server can allocate to customers as requests for enrolment are made, and the customer information related to those newly allocated identifiers would then be provided back to the retailer on a batch basis rather than at the moment the enrolment request is made.
c) Process a lookup request from a retailer's point of sale system to convert the user's unique ID into the retailer's own loyalty programme ID for that user. When the customer taps or waves their phone at a contactless reader connected to a retailer's point of sale system, the identifier transmitted by the phone's contactless device is typically a single unique identifier corresponding to that device. In this case, the identifier needs to be converted to the retailer's corresponding retailer specific loyalty ID for that customer. To accomplish this, the reader sends the unique identifier as a request to the server, and receives in response the customer's identifier corresponding to this retailer.

In an alternative embodiment, the server would not need to provide the service described in c) above. The phone's contactless device could be configured to transmit a different identifier at each retailer, consisting of the retailer's own loyalty programme ID for that user. In this embodiment, when the phone is waved in front of the reader, the reader transmits the retailer's ID and the phone responds by transmitting the user's ID corresponding to this retailer. The phone rather than the server would thus do the conversion.

### Mobile Phone Interface

The Mobile Phone Interface provides users the ability to enrol in new retailer loyalty programmes by sending a simple request to the Central Server. The interface typically consists of sending an SMS message that contains a keyword such as the retailer's unique ID, typically a 4 to 6 character code or number. The user receives in response an SMS requesting confirmation of the enrolment request, with other information such as the retailer's full name, location, the cost of joining the programme, etc. The user sends a confirmation SMS and then, if the enrolment is approved, receives in return a final SMS providing the user's new loyalty card ID number relevant to this retailer.

FIG. 2 shows the exchange of SMS messages that occurs when a customer initiates a request for enrolment. In step 1, the user sends a simple SMS message to the server. In step 2, the user receives an SMS describing the request that the user just made and requesting confirmation. In step 3, the user sends a simple confirmation message for authentication and tracking purposes. In step 4, the server sends a final message informing the customer that enrolment was successful.

Alternatively, the Mobile Phone Interface could be an application on phones equipped with Internet access, to avoid multiple SMS messages sent back and forth. In this embodiment, the phone accesses a web screen that includes a field for the customer to enter the same 4 to 6 character retailer loyalty programme ID as described above. Upon entering the ID, the screen displays the retailer's full name, location, the cost of joining the programme, etc. To confirm enrolment, the user then simply presses a confirmation button.

### Contactless Device

The Contactless Device is embedded within the user's mobile phone, or attached to the mobile phone, or, if the user prefers, attached to other portable devices, such as a key ring. The Contactless Device provides short-range wireless connectivity for “tap and go” functionality when the device is held near a contactless reader.

The Contactless Device is typically an NFC (Near Field Communications) chip embedded within the mobile phone, so that the phone can be tapped or waved in front of a reader. Examples of such handsets include the Nokia 6131 NFC phone and the Nokia 6212 Classic. When phones do not have the capability built in, the device can be in the form of a small sticker that the user attaches to their mobile phone, or to any other portable object that the user prefers, such as a key ring. Examples of such stickers include the GO-Tag supplied by First Data, and similar products provided by Inside Contactless (www.insidecontactless.com) and On Track Innovations (www.otiglobal.com).

In the preferred embodiment, the Portable Contactless Device transmits a single unique identifier. The user provides this identifier when registering for the first time at the Registration Website. When the phone is tapped or waved in front of a Contactless Reader, the unique identifier is sent to the Central Server as a request for the retailer's own loyalty programme ID that corresponds to that user.

In an alternative embodiment, the Portable Contactless Device could be a barcode sticker, where the barcode ID is the same single unique identifier which is broadcast by the NFC sticker described above.

### Contactless Reader

The Contactless Reader is attached to the retailer's point of sale system. It is typically the same device used for processing contactless payment cards such as Visa Paywave and MasterCard PayPass cards. Providers of such readers include companies like VIVOtech (www.vivotech.com) and On Track Innovations (www.otiglobal.com).

In the preferred embodiment, the Contactless Reader also has access to a communications network, typically the Internet, in order to communicate with the Central Server. Access can be provided either through an Internet connection directly built into the reader, or via access through the retailer's point of sale system, to which the reader is also attached. When a Portable Contactless Device is waved in front of the Contactless Reader, the Contactless Reader reads the Portable Contactless Device's unique identifier and sends the unique identifier to the Central Server as a request for the retailer's own loyalty programme ID corresponding to that user. When the Contactless Reader receives the user's corresponding loyalty ID, this ID is sent to the retailer's point of sale system that the Contactless Reader is connected to. The point of sale system then uses the ID in the same way that similar identifiers are used when the retailer's existing plastic cards are swiped or scanned.

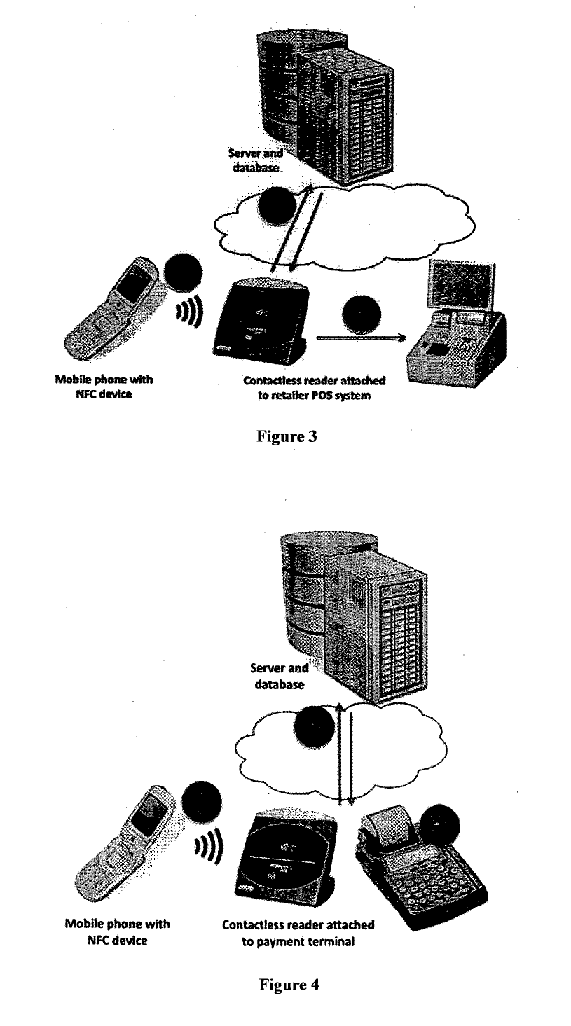

FIG. 3 shows the process of converting the mobile phone's unique NFC identifier into the corresponding retailer specific loyalty programme identifier corresponding to that user. In step 1, the mobile phone's NFC chip transmits the unique identifier to the contactless reader. In step 2, the reader sends the unique NFC identifier to the server, along with an identifier that indicates at which retailer the reader is installed, and receives in return the corresponding retailer specific loyalty identifier for this user. In step 3, the retailer specific identifier is sent to the retailer's point of sale system. The lookup and conversion process described here is the reason why the present invention does not require the customer to pre-select a virtual card to present at the checkout, unlike mobile wallet applications described previously. In most cases, the customer does not even have to open the phone before tapping it against the reader.

In another embodiment, the Contactless Reader is a common barcode scanner capable of reading the barcode on the customer's mobile device. Once the customer's barcode is scanned, the unique ID is sent to the server as described above, and the retailer specific loyalty ID is received in response, then processed by the retailer's point of sale system just as if the customer's normal card had been scanned.

In yet another embodiment, the contactless reader is attached to a payment terminal typically used to process credit and debit card transactions. When the phone in FIG. 4 is tapped against the reader (step 1) the payment terminal obtains from the server the customer's retailer specific identifier and then displays the identifier on the payment terminal's display. The clerk then knows that the customer is a member of the retailer's program, and can provide a discount and even key in the identifier manually on the cash register.

### Flowcharts

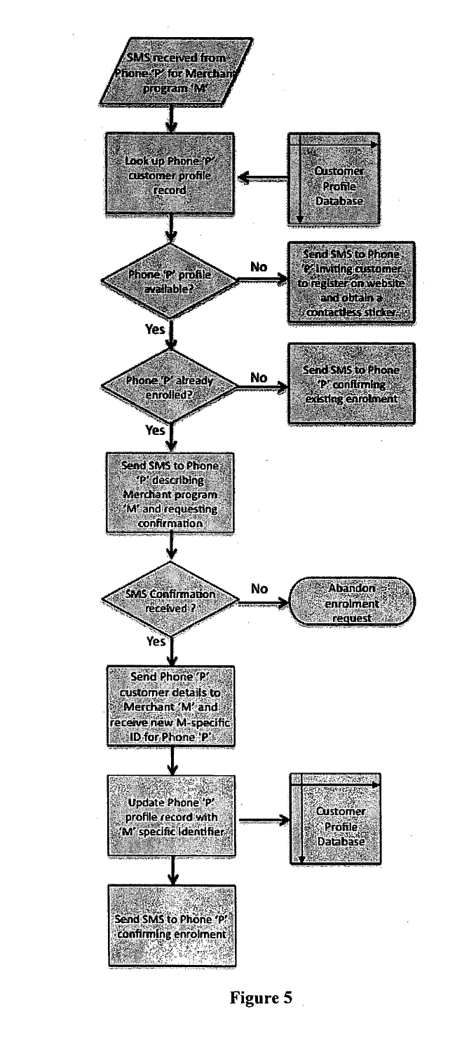

Flowchart 1 (shown as FIG. 5) describes the server's automated enrolment process. The server receives an electronic enrolment request for merchant program M from mobile phone number P, typically through an SMS message. The server looks up phone P's profile in the customer profile database. If no profile is available, an SMS is sent to the originating phone inviting the customer to register on the website and obtain a contactless sticker. If a profile is available, the server checks if phone P is already a member of merchant program M, in other words, that the merchant-specific identifier for M is already present in P's customer profile record. If the customer is already a member, an SMS is sent confirming the existing membership. If the customer is not yet a member, an SMS is sent to the customer, describing merchant program M and requesting enrolment confirmation. If no confirmation is received, the request is abandoned. Upon receiving confirmation, phone P's customer details are sent to merchant M and the server receives in return a new M-specific identifier for phone P. The server updates phone P's profile with the new M-specific identifier and an SMS is sent to the customer confirming enrolment.

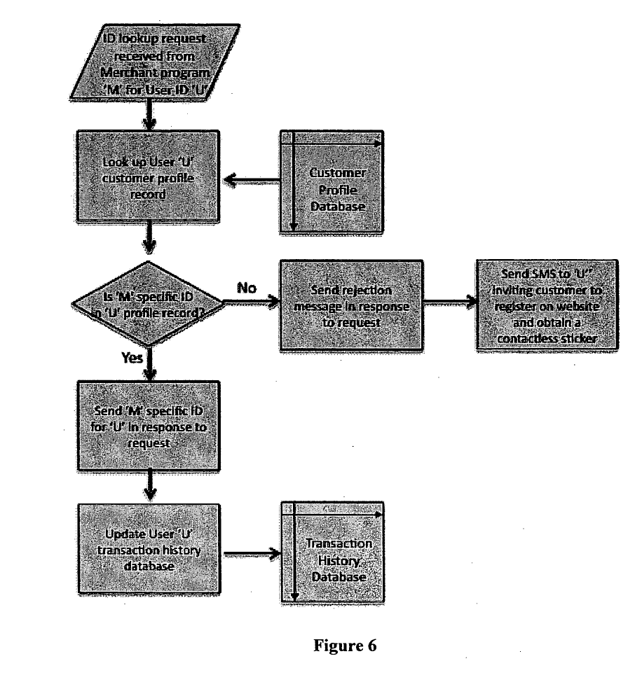

Flowchart 2 (shown as FIG. 6) describes the server's ID conversion process, where the merchant's point of sale system sends a request to the server for conversion of a phone's unique identifier into the merchant's identifier for this customer. The server first receives an ID lookup request from Merchant program ‘M’ for User ID ‘U’. The server looks up the customer profile record for User ‘U’. If the ‘M’ specific ID is not present in this profile record, a rejection message is sent in response to the request from the point of sale system and an SMS is sent to invite the customer to register on the website and obtain a contactless sticker. If the ‘M’ specific ID is present, then ‘U’ is a member. In this case, the ‘M’ specific ID is sent in response to the request from the merchant and the server updates the transaction history database.

### Other Features of the Invention

If upon tapping the phone to a reader, the server determines that the customer is not a member enrolled in this merchant's program (because the customer does not have an identifier related to this merchant stored in the customer's profile on the server), the system will automatically send an electronic text message to the customer's phone inviting them to join the program through the enrolment process described previously.

The Registration Website also allows users to add their existing loyalty cards to their registration profile so that they don't need to keep all of their cards in their wallets. The Registration Website includes fields that allow a user to add retailer specific identifiers corresponding to loyalty cards that the user already has. The website is designed to obtain approval from the retailer's loyalty system before adding the retailer specific identifiers to the customer's account and linking the newly entered identifiers to a customer's unique NFC contactless ID.

Sometimes multiple customers need to share a single retailer specific identifier, for example in the case of a single card account for a household, and some retailers allow for this possibility. The Registration Website allows a customer to register one or more of his or her retailer specific identifiers to the accounts of other users, with approval from the retailer or retailers.

Another additional feature of the invention is to provide customers the ability to search for retailer programmes that they might be interested in joining. This capability is possible through a normal website or a mobile website. When the customer discovers a programme of interest and chooses to join it, enrolment occurs as described in the present patent, through a simple one step confirmation process.

As is self-evident, and as results from the foregoing, the present invention is not limited to the embodiments described here. On the contrary it embraces all variants thereof, including the use of any unique identifier technology with similar capabilities to barcodes, NFC, RF-ID, etc. It also embraces all variants of membership cards, including prepaid cards which provide merchants the ability to register prepaid funds on behalf of a customer, who then uses the funds to pay for purchases.

Modifications and improvements to the invention will be readily apparent to those skilled in the art. Such modifications and improvements are intended to be within the scope of this invention.

In this specification where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

The word “comprising” and forms of the word “comprising” as used in this specification does not limit the invention claimed to exclude any variants or additions.

1.-34. (canceled)

35. A server in an automated membership system providing membership in a programme offered by a vendor, benefits associated with the programme conferred in connection with a transaction based on a first interaction between a reader associated with the vendor and an article, the server comprising:
a network interface;
a data storage device having a database; and
a processor coupled to the data storage device and the network interface, the processor configured to:
store user profile data in the database, the user profile data including data representing a unique user identifier and other information associated with a user;
receive a request message during a second interaction separate from the first interaction, the request message including a vendor identifier and the user identifier, the request message generated from a web screen, the request message based on an input associated with the web screen, the request message for requesting to establish and store an association between the user identifier and the vendor;
provide an indication to the vendor during the transaction of the association between the vendor and the user identifier based on the first interaction whether or not to enable the benefits associated with the programme to be conferred.

36. A server according to claim 1, wherein the processor is further configured to provide the profile data to the vendor in response to the request message, the profile data for creating a membership with the vendor, the membership containing an association between the user identifier and the vendor identifier.

37. A server according to claim 1, wherein the other information includes one of a payment detail history and an activity history, including any existing programme memberships.

38. A server according to claim 2, wherein the processor is further configured to cause an input user interface to be generated at the web screen for inputting a data field associated with providing one of: the identifier; and the other information.

39. A server according to claim 1, wherein the vendor creates the membership according to a criteria obtained from the profile data.

40. A server according to claim 1, wherein the other information includes one of: a name; a contact or residential address; a contact number; and billing account details.

41. A server according to claim 1, wherein the request message includes one of: an electronic message; a Short Message Service (SMS) message; and a Multimedia Messaging Service (MMS) message.

42. An article in an automated membership system providing membership in a programme offered by a vendor, benefits associated with the programme conferred in connection with a transaction based on a first interaction between a reader associated with the vendor and an article, the membership system including a server, the article comprising:
a communication media configured to communicate with the reader, the communication media including one of: a near field radio transmitter device; a mobile telecommunications device; a label including one or more markings representing said identifier; and a bar code label; and
a user identifier;
wherein the server is configured to:
store user profile data in the database, the user profile data including data representing the user identifier and other information associated with a user;
receive a request message during a second interaction separate from the first interaction, the request message including a vendor identifier and the user identifier, the request message generated from a web screen, the request message based on an input associated with the web screen, the request message for requesting to establish and store an association between the user identifier and the vendor;
provide an indication to the vendor during the transaction of the association between the vendor and the user identifier based on the first interaction whether or not to enable the benefits associated with the programme to be conferred.

43. An article according to claim 8, wherein the server is further configured to provide the user profile data to the vendor in response to receiving the request message, the user profile data for creating a membership with the vendor based on the identifier.

44. An article according to claim 8, wherein the reader reads the data from the article without coming into contact with the article.

45. An article according to claim 8, wherein the reader reads the data from the article using Near Field Communications (NFC) technology.

46. An article according to claim 8, wherein the communication media including the identifier is removably attachable to an item.

47. An article according to claim 8, wherein the transaction includes one of: a reward transaction; a payment transaction; and a prepaid payment transaction, the prepayment made in advance to and held on account by the vendor.

48. A method for providing membership in a programme offered by a vendor, benefits associated with the programme conferred in connection with a transaction based on a first interaction between a reader associated with the vendor and an article, the membership system including a server, the method comprising:
storing user profile data including data representing a unique user identifier and other information associated with a user;
generating a request message during a second interaction separate from the first interaction, the request message including a vendor identifier and the user identifier, the request message generated from a web screen associated with the vendor, the request message based on an input associated with the web screen, the request message for requesting to establish and store an association between the user identifier and the vendor; and
indicating to the vendor during the transaction of the association between the vendor and the user identifier based on the first interaction whether or not to enable the benefits associated with the programme to be conferred.
